(19) United States
(12) Patent Application Publication
(10) Pub. No.: US 2009/0172199 A1
(43) Pub. Date: Jul. 2, 2009

(54) METHOD AND SYSTEM FOR CALIBRATING RESPONSE OF POINTER WITH RESPECT TO MOUSE

(75) Inventor: Shih-Yuan Huang, Shijr City (TW)

Correspondence Address: KIRTON AND MCCONKIE, 60 EAST SOUTH TEMPLE,, SUITE 1800, SALT LAKE CITY, UT, 84111, US

(73) Assignee: ATEN INTERNATIONAL CO., LTD., Taipei (TW)

(21) Appl. No.: 11/966,114

(22) Filed: Dec. 28, 2007

(51) Int. Cl. G06F 15/16

(52) U.S. Cl. 709/248

(57) ABSTRACT

Disclosed is a method for calibrating response of a pointer of a remote computer with respect to a mouse of a client computer. The method of the present invention includes steps: (a) showing the pointer of the remote computer in a screen of a display of the client computer; (b) directing the pointer to move in a predetermined distance by shifting the mouse; (c) calculating a relation between a shift of the mouse and the predetermined distance; and (d) synchronizing the mouse with the pointer according to the relation. The system thereof according to the present invention includes a KVM switch and a calibration mechanism. The KVM switch shows the pointer in the screen of the display. The calibration mechanism calculates a relation between a shift of the mouse and a predetermined distance and then, synchronizes the mouse with the pointer according to the relation.

### BACKGROUND OF THE INVENTION

1. Field of the Invention

The present invention generally relates to a method for calibrating response of a pointer with a mouse, and more particularly to a method for calibrating response of a pointer of a remote computer with respect to a mouse of a client computer in a KVM switch system.

2. Description of Prior Art

In general, a user of a KVM switch system is asked to set a pointer speed of a remote computer to the middle position i.e. neither accelerated nor decelerated before he is going to set up or to manipulate the remote computer at a client computer thereof. The reason why such a pre-setting of the remote computer is necessary is to avoid a situation that two pointers (cursors) appear in a screen of a display of the client computer at the same time and the two pointers cannot line up (not synchronized). One of the aforesaid pointers belongs to the client computer and the other is generated by the remote computer and shown in a screen of the display. Hence, a drawback of two incompatible pointers is indeed bothersome to the user when operating the remote computer if the pre-setting for the pointer speed is dropped.

Therefore, the pre-setting of the remote computer always has to be executed, and so the client computer can exactly predict the pointer's position and obtain right response of the pointer of the remote computer with respect to the mouse of client computer.

Please refer to FIG. 1, which shows a screen of the client computer's display, showing traces of two pointers belonging to the remote computer and the client computer directed by a mouse of the client computer if a pointer speed setting of the remote computer is accelerated. For example, both pointers of the remote computer and the client computer are at the same position. Two pointers overlap and show only one pointer 102.

However, if the pointer speed setting of the remote computer is accelerated as aforementioned in prior arts and the user of the client computer shifts the mouse toward right-bottom direction as shown in FIG. 1, the pointer of the remote computer is directed with speed acceleration and reaches a certain distance to show a pointer 104 as shown in FIG. 1. The pointer of the client computer is directed with no acceleration but reaches about half the distance to show as a pointer 106 as shown in FIG. 1. The client user obviously finds that the feeling of controlling the client pointer of the client computer is different from that of controlling the remote pointer of the remote computer when moving the client mouse of the client computer.

Moreover, such non-accelerated setting also can be another drawback to the user when manipulating the remote computer at the client computer, because the pointer's movement like creeping may slow down and trap the operation of the user.

### SUMMARY OF THE INVENTION

Consequently, there is a need to develop a method and a system for calibrating response of a pointer with respect to a mouse.

An objective of the present invention is to provide a method for calibrating response of a pointer of a remote computer with respect to a mouse of a client computer when a pointer speed setting of the remote computer is accelerated.

Another objective of the present invention is to provide system for calibrating response of the pointer with respect to the mouse for maintaining the pointer being directed precisely with respect to a shift of the mouse.

The method of the present invention includes steps:

showing the pointer of the remote computer in a screen of a display of the client computer;

directing the pointer to move in a predetermined distance by shifting the mouse;

calculating a relation between a shift of the mouse and the predetermined distance; and

synchronizing the mouse with the pointer according to the relation.

The relation is related with a pointer speed setting of the remote computer. A calibration mechanism of the client computer creates at least two artificial marks in a screen of a display of the client computer. The predetermined distance is defined by the at least two artificial marks. A user of the client computer can manually shift the mouse to direct the pointer crossing the two artificial marks. Alternatively, the pointer can be automatically directed by the calibration mechanism of the client computer. The system for calibrating response of the remote pointer with respect to the client mouse includes a remote computer, a client computer, a KVM switch and the aforesaid calibration mechanism which can be application software installed and configured in the client computer. The remote computer has the remote pointer and the client computer connects to the client mouse. The KVM switch connects to the remote computer and the client computer, respectively and shows the remote pointer in a screen of the display of the client computer. The calibration mechanism calculates a relation between a shift of the client mouse and a predetermined distance and then, synchronizes the client mouse with the remote pointer according to the relation.

The system for calibrating response of the remote pointer with respect to the client mouse for a iKVM includes a remote computer, a client computer, a iKVM switch and the aforesaid calibration mechanism which can be application software installed and configured in the client computer. Similarly, the remote computer has the remote pointer and the client computer connects to the client mouse. The iKVM switch, which is directly connected to the remote computer and connected to the client computer via a network, shows the remote pointer in a screen of a display of the client computer. The calibration mechanism calculates a relation between a shift of the client mouse and a predetermined distance and then, synchronizes the client mouse with the remote pointer according to the relation.

### BRIEF DESCRIPTION OF THE DRAWINGS

FIG. 1 shows a screen of the client computer's display, showing traces of two pointers respectively belonging to the remote computer and the client computer directed by a mouse of the client computer if a pointer speed setting of the remote computer is accelerated.

FIG. 2 depicts a diagram of a KVM switch system in which a user manipulates a remote computer at a client computer through LAN or Internet according to the present invention.

FIG. 3 depicts an embodiment of a method for calibrating response of a pointer of a remote computer according to the present invention.

FIG. 4 depicts a flow chart of a method for calibrating response of the pointer of the remote computer according to the present invention.

### DETAILED DESCRIPTION OF THE INVENTION

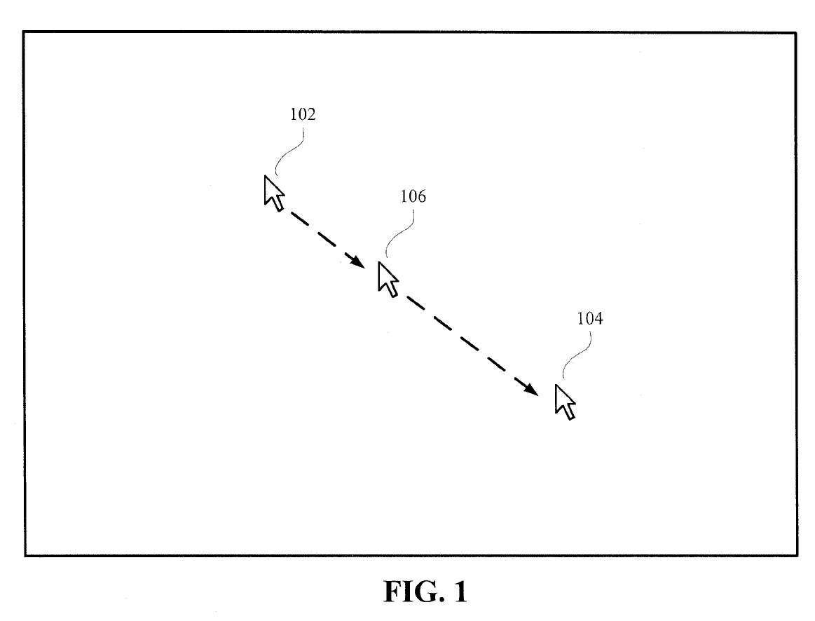

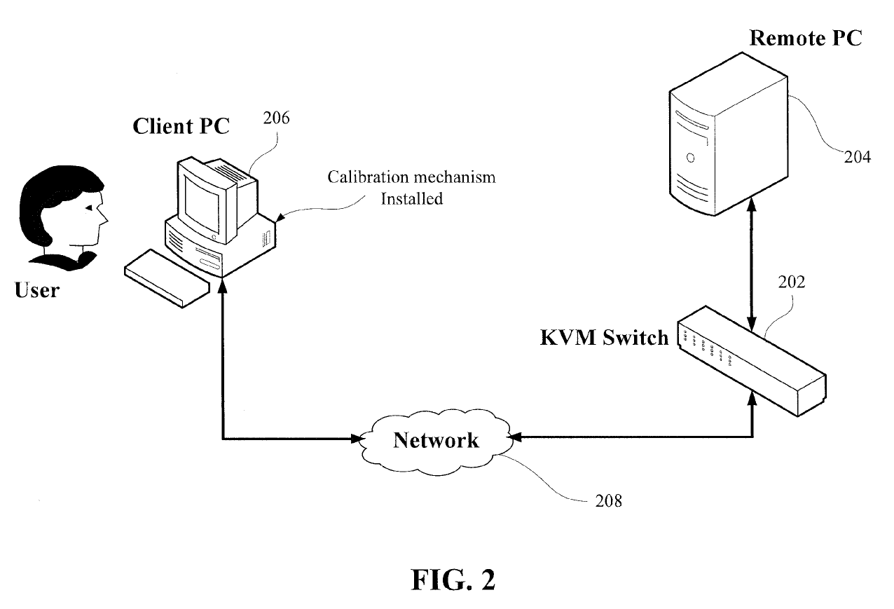

Please refer to FIG. 2, which depicts a diagram of a KVM switch system having a KVM switch 202 (such as an iKVM, i.e. KVM switch over IP). In the KVM switch system, a user manipulates a remote computer 204 at a client computer 206 through network 208. The system for calibrating response of a remote pointer of the remote computer 204 with respect to a client mouse of the client computer 206 includes the remote computer 204, the client computer 206, the iKVM switch 202 and a calibration mechanism, such as application software installed and configured in the client computer. The remote computer 204 has the remote pointer and the client computer 206 connects to the client mouse (not shown in FIG. 1). In this embodiment, the KVM switch 202 is directly connected to the remote computer and connected to the client computer via a network. The KVM switch 202 shows the pointer in a screen of the display of the client computer 206. The calibration mechanism calculates a relation between a shift of the client mouse and a predetermined distance and then, synchronizes the client mouse with the remote pointer according to the relation (More related explanation is later). In one embodiment, the network 208 includes Internet, Ethernet, Intranet, Local area network (LAN), Wide area network (WAN) or wireless network.

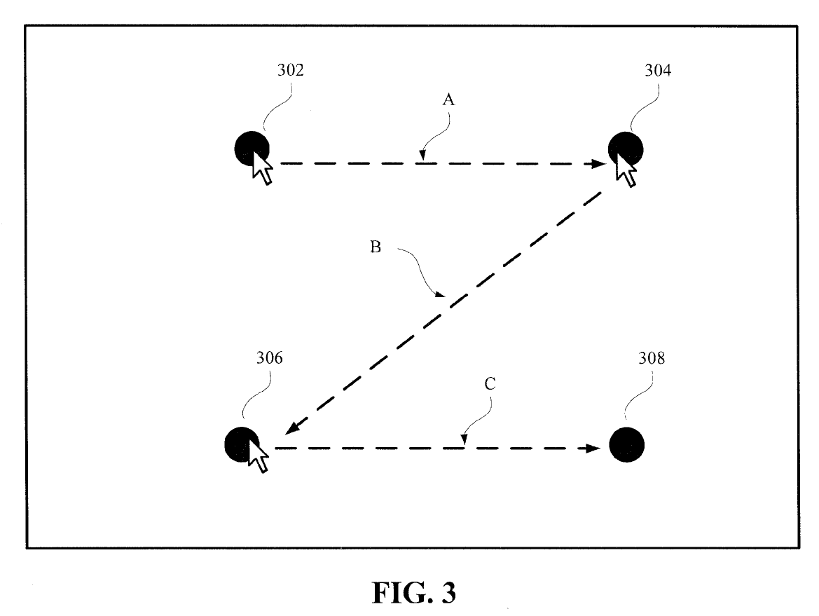

Please refer to FIG. 3, which depicts an embodiment of a method for calibrating response of a pointer of a remote computer according to the present invention. First, the user sets the pointer speed of the client computer at a constant pointer speed. Next, the aforesaid calibration mechanism of the client computer creates at least two artificial marks on the display of the client computer. In this embodiment, the calibration mechanism can create at least two artificial marks, such as artificial marks 302, 304, 306 and 308 in the screen of the display in the beginning. Then, the user shifts the mouse of the client computer to direct the pointer overlapping the pointer of the remote computer at the artificial mark 302 and pushes the left button of the mouse to confirm the position. And then, the user shifts the mouse to direct the pointers crossing a distance from the artificial mark 302 to the artificial mark 304 along the broken line A and pushes the left button. And then, the user continues to direct the pointers crossing a distance from the artificial mark 304 to the artificial mark 306 along the broken line B, and a distance from the artificial mark 306 to the artificial mark 308 along the broken line C.

Once the relation between a shift of the mouse and the distance is calculated in any one step above, the calibration mechanism of the client computer can inform the user to terminate the following steps thereafter. The relation calculated by the calibration mechanism is mathematically related with a pointer speed setting of the remote computer. Thereafter, synchronizing the mouse with the pointer according to the relation can be realized and the drawbacks of prior art can be eliminated without considering the pointer speed of the remote computer. In one embodiment, the predetermined distance may be formed by two marks, such as marks 302 and 304, marks 302 and 306, marks 302 and 308. In other embodiment, the predetermined distance may be formed by third marks, such as marks 302, 304 and 306, marks 302, 304 and 308, marks 304, 306 and 308. Alternatively, only the artificial mark 302 can be created at first. After the user pushes the left button of the mouse to confirm the position, the artificial mark 304 shows up for the user to direct the pointers crossing the distance therebetween and so on.

Furthermore, the calibration mechanism can automatically direct the pointers to complete the aforesaid calibration for response of the pointer of the remote computer with respect to the mouse of the client computer without user's manual operation as aforementioned. Moreover, when the user manually shifts the mouse, it may be difficult for the user to direct the pointer straightly. The calibration mechanism can omits the shift of mouse in other direction but only direct the pointer in the straight broken lines A, B, or C to calculate the relation correctly. Moreover, the user can set the pointer speed of the client computer at other constant pointer speed to proceed the calibration if the calibration mechanism judges that the relation for the other constant pointer speed is necessary, too.

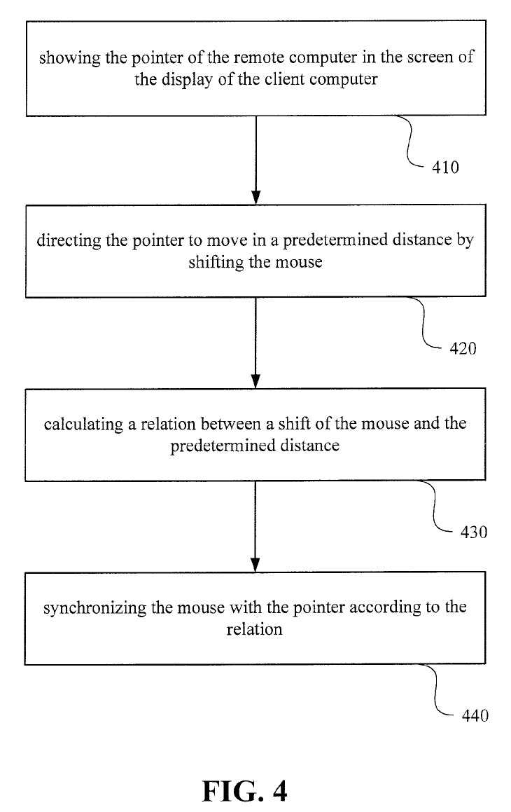

Please refer to FIG. 4, which depicts a flow chart of a method for calibrating response of the pointer of the remote computer according to the present invention. The method of the present invention includes the follow steps:

Step 410, showing the pointer of the remote computer in a screen of a display of the client computer;

Step 420, directing the pointer to move in a predetermined distance by shifting the mouse;

Step 430, calculating a relation between a shift of the mouse and the predetermined distance; and

Step 440, synchronizing the mouse with the pointer according to the relation.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for calibrating response of a pointer of a remote computer with respect to a mouse of a client computer, the method comprising steps of:
showing the pointer of the remote computer in a screen frame of a display of the client computer;
directing the pointer to move in a predetermined distance by shifting the mouse;
calculating a relation between a shift of the mouse and the predetermined distance; and
synchronizing the mouse with the pointer according to the relation.

2. The method according to claim 1, wherein the relation is related with a pointer speed setting of the remote computer.

3. The method according to claim 1, wherein the mouse of the client computer is set at a constant pointer speed before the step of directing the pointer.

4. The method according to claim 1, wherein the predetermined distance is defined by at least two artificial marks in the screen frame of the display.

5. The method according to claim 4, wherein a user of the client computer manually shifts the mouse to direct the pointer of the remote computer crossing the two artificial marks in the screen frame of the display.

6. The method according to claim 4, wherein the two artificial marks are created by a calibration mechanism of the client computer.

7. The method according to claim 1, wherein the pointer is automatically directed by a calibration mechanism of the client computer.

8. The method according to claim 7, wherein the calibration mechanism is application software installed in the client computer.

9. A system for calibrating response of a remote pointer with respect to a client mouse, the system comprising:
a remote computer having the remote pointer;
a client computer connected to the client mouse;
a KVM switch, connected to the remote computer and the client computer, respectively, the KVM switch showing the remote pointer in a screen of a display of the client computer; and
a calibration mechanism configured in the client computer, the calibration mechanism calculating a relation between a shift of the client mouse and a predetermined distance by shifting the client mouse according to the remote pointer directed in the predetermined distance to synchronize the client mouse with the remote pointer according to the relation.

10. The system according to claim 9, wherein the relation is related with a pointer speed setting of the remote computer.

11. The system according to claim 9, wherein the calibration mechanism sets the client mouse at a constant pointer speed before the pointer is directed.

12. The system according to claim 9, wherein the calibration mechanism automatically directs the remote pointer.

13. The system according to claim 9, wherein the calibration mechanism defines the predetermined distance by at least two artificial marks in the screen of the display.

14. The system according to claim 13, wherein a user of the client computer manually shifts the client mouse to direct the remote pointer crossing the two artificial marks in the screen of the display.

15. The system according to claim 9, wherein the calibration mechanism is application software installed in the client computer.

16. The system according to claim 9, wherein the KVM switch is directly connected to the remote computer.

17. The system according to claim 9, wherein the KVM switch is connected to the client computer via a network.

18. The system according to claim 17, wherein the network includes Internet, Ethernet, Intranet, Local area network (LAN), Wide area network (WAN) or wireless network.

19. A system for calibrating response of a remote pointer with respect to a client mouse, the system comprising:
a remote computer having the remote pointer;
a client computer connected to the client mouse;
a iKVM switch, directly connected to the remote computer, connected to the client computer via a network, the KVM switch showing the remote pointer in a screen of a display of the client computer; and
a calibration application installed in the client computer, the calibration mechanism calculating a relation between a shift of the client mouse and a predetermined distance by shifting the client mouse according to the remote pointer directed in the predetermined distance to synchronize the client mouse with the remote pointer of the client computer according to the relation.

20. The system according to claim 19, wherein the network includes Internet, Ethernet, Intranet, Local area network (LAN), Wide area network (WAN) or wireless network.
